(19) United States
(12) Patent Application Publication
(10) Pub. No.: US 2010/0225932 A1
(43) Pub. Date: Sep. 9, 2010

(54) IMAGE FORMING APPARATUS AND IMAGE FORMING METHOD

(75) Inventors: Mitsukazu KUROSE, Shiojiri-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/706,973

(22) Filed: Feb. 17, 2010

(30) Foreign Application Priority Data
Mar. 6, 2009 (JP) 2009-053300

(51) Int. Cl. G06F 3/12

(52) U.S. Cl. 358/1.1

(57) ABSTRACT

An image forming apparatus includes a latent image carrier on which a latent image is formed. The latent image is developed, and the developed image is transferred onto a recording target medium. A fixing section thermally fixes the recording target medium on which the image has been transferred. A storing section stores variation information regarding variation in size of the thermally fixed recording target medium. An image data processing section processes image data for transfer on a first side of the recording target medium based on the variation information. A data outputting section outputs the processed image data for transfer on the first side of the recording target medium and outputs image data for a second side of the recording target medium, which has not been processed by the image data processing section, to transfer the image data on the second side of the recording target medium.

### BACKGROUND

1. Technical Field

The present invention relates to an image forming apparatus and an image forming method for registering the front of a recording target medium and the back thereof with high precision when double-side printing is performed.

2. Related Art

A digital printing machine is sometimes used to print images such as text, graphics, and the like on both sides of a piece of paper. When double-side printing is performed, it is necessary to register the leading edge position of the front side of paper and the leading position of the reverse side thereof. When an image is printed on, after the completion of image fixation processing on one side (the front) of paper, the other side (the back) thereof, the paper is affected by shrinkage that occurs due to heat applied in the course of the fixation processing. For this reason, it is necessary to perform registering processing on the paper. In the registering, print image size correction processing and print image position correction processing are performed.

In connection with the above, the following technique is disclosed in JP-A-2005-301240. Either the magnification of a yet-to-be-fixed image formed on a piece of transfer paper or the position of the yet-to-be-fixed image, or both of the magnification and the position thereof, is/are determined on the basis of an image pattern detected by an image pattern detection sensor and image data. An image formation means performs correction processing for image formation on the basis of the determination. The following technique is disclosed in JP-A-2008-129543. An apparatus includes a leading edge detection sensor and a mark detection sensor. The leading edge detection sensor detects the leading edge of the back of a piece of transfer paper. Using the leading edge of the back of the paper detected by the leading edge detection sensor as a reference edge, the mark detection sensor detects the formation position of a reference mark on the paper. An image forming unit transfers an image on the back for image formation on the basis of the formation position of the reference mark on the paper, which has been detected by the mark detection sensor with the use of the leading edge of the back of the paper as reference. The following technique is disclosed in JP-A-2005-138575. A print adjustment standard value and a print adjustment offset value stored in association with each recording medium feeding tray are read out depending on the type of recording medium feeding tray or the type of recording medium to be printed. Print adjustment is carried out for each of the front and the back of the recording medium on the basis of the read-out print adjustment standard value and the adjusted value.

The scheme disclosed in JP-A-2005-301240 has the following problem. Since the sensor for detecting an image pattern is fixed at a position near the center in the main-scan direction, it is capable of performing detection in the sub-scan direction only. Therefore, it is actually impossible to correct the magnification and the position in the main scan direction. According to the scheme disclosed in JP-A-2008-129543, the sensor for detecting the leading edge of paper and the sensor for detecting the formation position of a reference mark are provided as two discrete sensors. The former is a transmissive-type sensor, whereas the latter is a reflective-type sensor. Therefore, a mounting position error pertinent to the detection of the position of a reference mark from the leading edge of paper and a detection error that is attributable to a difference in detection scheme therebetween and transmissive/reflective characteristics dependent on the type of paper occur. Accordingly, the scheme disclosed in JP-A-2008-129543 has a problem in that calibration is very difficult. In the scheme disclosed in JP-A-2005-138575, the front and the back of a recording target medium are registered on the basis of the print adjustment standard value and the print adjustment offset value. This scheme is inferior to, in terms of precision and quality, a scheme in which an image size detection sensor and an image position detection sensor are used to correct a next-print image size and a next-print image position for constant feedback.

In the front-back registering of a digital printing machine that uses a laser exposure device common to the related-art examples disclosed in JP-A-2005-301240, JP-A-2008-129543, and JP-A-2005-138575, which are explained above, a process speed, a polygon mirror rotation speed, and print data output timing are controlled to vary pixel pitch in the main scan direction and the sub scan direction, thereby correcting image size and print position for printing on the front and the back of a piece of paper. However, it is very complex to vary image magnification in the main scan direction and the sub scan direction with such a complex method, resulting in the disordering of process conditions. With the irregular process conditions, it can be said that such a control method is difficult in terms of print stability. In the configuration of a digital printing machine that uses a line head such as an LED array or the like as a light exposure device, pixel pitch in the main scan direction is fixed with one-to-one correspondence to the light-emitting-element pitch of the LED array. Therefore, with such a configuration, it is impossible to apply image magnification correction of the related art thereto. Moreover, the applying of print image size correction and print image position correction to print image data for a print image on a first side in advance while taking paper shrinkage due to thermal fixation and the like into consideration is not disclosed in any of the above patent documents.

### SUMMARY

An advantage of some aspects of the invention is to provide an image forming apparatus and an image forming method for registering the front of a recording target medium and the back thereof with high precision when double-side printing is performed.

An image forming apparatus according to a first aspect of the invention includes: a line head on which a plurality of light emission elements is arranged in a first direction; a latent image carrier on which a latent image is formed; a developing section that develops the latent image; a transferring section that transfers the image developed by the developing section onto a recording target medium; a fixing section that performs thermal fixing on the recording target medium on which the image has been transferred; a storing section that stores information on variation in size of the thermally fixed recording target medium; an image data processing section that processes image data for transfer on a first side of the recording target medium on the basis of the variation information stored in the storing section; and a data outputting section that outputs the processed image data for transfer on the first side of the recording target medium and outputs image data for a second side of the recording target medium, which has not been processed by the image data processing section, to transfer the image data on the second side of the recording target medium.

It is preferable that an image forming apparatus according to the first aspect of the invention should further include: a recording target medium selecting section that selects a type of the recording target medium; and a variation information correcting section that corrects the information on variation in size of the thermally fixed recording target medium on the basis of the type of the recording target medium selected by the recording target medium selecting section.

In the configuration of an image forming apparatus according to the first aspect of the invention, it is preferable that the image data processing section should include a screen processing section that performs screen processing on the image data; and the screen processing on the image data should be performed on the basis of the information on variation in size of the thermally fixed recording target medium.

An image forming apparatus having the preferred configuration described above may further include an image position correcting section that performs image position correction processing on the screen processed image data to correct a position of the image data.

It is preferable that an image forming apparatus according to the first aspect of the invention should further include a detecting section that detects a position of a mark formed on the recording target medium.

An image forming method according to a second aspect of the invention includes: acquiring information on variation in size of a thermally fixed recording target medium and then performing screen processing on image data on the basis of the acquired variation information; correcting a position of the screen processed image data; transferring a first image on a first side of the recording target medium by outputting the image data that has been subjected to the screen processing and the position correction and then performing thermal fixing on the recording target medium on which the first image has been transferred; and transferring a second image on a second side of the recording target medium and then performing thermal fixing on the recording target medium on which the second image has been transferred.

### BRIEF DESCRIPTION OF THE DRAWINGS

The invention will be described with reference to the accompanying drawings, wherein like numbers reference like elements.

FIG. 1 is a block diagram that schematically illustrates an example of a configuration according to an exemplary embodiment of the invention.

FIG. 2 is a diagram that schematically illustrates an example of an overall configuration according to an exemplary embodiment of the invention.

FIG. 3 is a block diagram that schematically illustrates an example of a configuration according to an exemplary embodiment of the invention.

FIG. 4A is a set of diagrams according to an exemplary embodiment of the invention.

FIG. 4B is a set of diagrams according to related art.

FIG. 5 is a diagram according to an exemplary embodiment of the invention.

FIG. 6A is a diagram according to an exemplary embodiment of the invention.

FIG. 6B is a diagram according to an exemplary embodiment of the invention.

FIG. 6C is a diagram according to an exemplary embodiment of the invention.

FIG. 7 is a diagram according to an exemplary embodiment of the invention.

FIG. 8 is a block diagram that schematically illustrates a modification example of a configuration according to an exemplary embodiment of the invention.

FIG. 9A is a block diagram that schematically illustrates an example of a configuration according to related art.

FIG. 9B is a block diagram that schematically illustrates an example of a configuration according to an exemplary embodiment of the invention.

FIG. 10 is a block diagram that schematically illustrates an example of a configuration according to related art.

FIG. 11 is a block diagram that schematically illustrates an example of a configuration according to related art.

FIG. 12 is a block diagram that schematically illustrates an example of a configuration according to related art.

FIG. 13A is a diagram that illustrates the base background technique of the invention.

FIG. 13B is a diagram that illustrates the base background technique of the invention.

### DESCRIPTION OF EXEMPLARY EMBODIMENTS

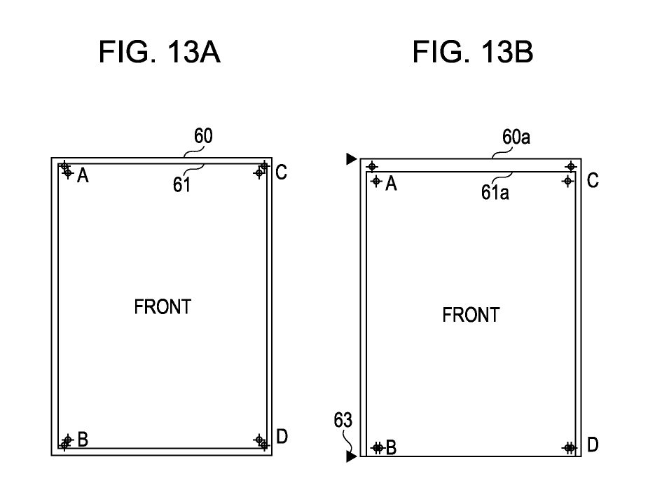

With reference to FIG. 13, which shows the base background technique of the present invention, processing for printing images on both sides of a piece of paper is explained below. FIG. 13A is a diagram that schematically illustrates an example of the state of a sheet of paper when an image is printed on the front thereof. FIG. 13B is a diagram that schematically illustrates an example of the front state of a sheet of paper after the printing of an image also on the back thereof. The outer frame shown in FIG. 13A represents the size of a sheet of paper before the printing of an image on the front thereof, which is denoted as 60. The inner frame represents the size of the paper after the fixation of an image on the front thereof, which is denoted as 61.

In this example, the size of the sheet of paper changes due to paper shrinkage that occurs in the course of image fixation processing. The sheet has marks A, B, C, and D called as register marks (tombo) at four corners thereof. These register marks A, B, C, and D are used as alignment marks at the time of double-side printing (i.e., duplex printing). That is, the register marks are marks printed on, for example, the center of each of the top edge, the bottom edge, the left edge, and the right edge of paper and four corners thereof in the process of creating a printed matter for the purpose of registering (i.e., aligning) the leading edge position of the front side of the paper and the leading edge position of the reverse side thereof, registering the leading edge position of the paper for multiple color printing, and registering the position for cutting a printed sheet into sheets each having a predetermined cut size. In the example illustrated in FIG. 13, the sheet has register marks at four corners.

FIG. 13B shows the state of the front of a sheet of paper after the printing of an image also on the back thereof. The reference numeral 62 that is shown in FIG. 13B denotes the detected position of a front-side edge of the sheet of paper. The reference numeral 63 denotes the detected position of a reverse-side edge of the sheet of paper. The reference numeral 60a denotes the size of the sheet of paper before the printing of an image on the front thereof and the position of the leading edge of the sheet. The reference numeral 61a denotes the size of the sheet of paper after image fixation on the front thereof and the position of the leading edge of the sheet. As illustrated in FIG. 13B, the position of the start of printing for the front side of the sheet is different from the position of the start of printing for the reverse side of the sheet; accordingly, the positions of the register marks A, B, C, and D used as alignment marks differ therebetween. For this reason, a problem of a shift in the position of a printed image arises. An aspect of the invention addresses the above problem.

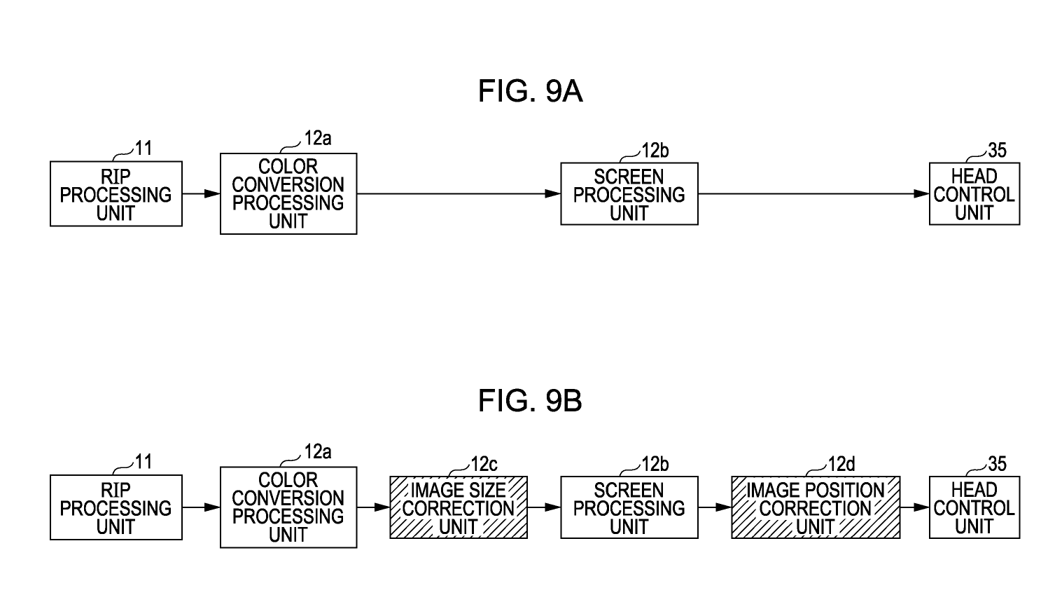

FIG. 9 is a set of block diagrams that schematically illustrates an example of the configuration of control processing blocks of related art and the configuration of control processing blocks of an exemplary embodiment of the invention. FIG. 9A shows processing blocks of related art. An RIP processing unit 11 shown in FIG. 9A converts vector data into raster data. A color conversion processing unit 12a performs color conversion from RGB data into CMYK data or from CMYK data into CMYK data on the basis of a device-dependent profile and the like. A screen processing unit 12b converts pixel data having tones after color conversion into binary area ratio gray scale. The data subjected to screen processing is sent to a head control unit (i.e., head controller) 35 as light exposure data.

FIG. 9B shows processing blocks according to an exemplary embodiment of the invention including an image size correction unit and an image position correction unit. An image size correction unit 12c is provided as an upstream block viewed from the screen processing unit 12b. Since the image size correction unit 12c performs processing before the processing of the screen processing unit 12b, it is possible to avoid a screen pattern from being disordered due to image size correction. In addition, a position correction unit 12d for correcting the position of image data is provided as a downstream block viewed from the screen processing unit 12b.

Since the position correction unit 12d performs processing after the processing of the screen processing unit 12b, the amount of data that has to be processed thereat can be reduced. Therefore, it is possible to substantially reduce the burden of position correction processing, which is required to be performed with a high speed. Specifically, image data before screen processing has data amount of eight bits per pixel, whereas image data after screen processing has data amount of one bit per pixel. Therefore, the amount of data that has to be processed can be reduced to an eighth thereof.

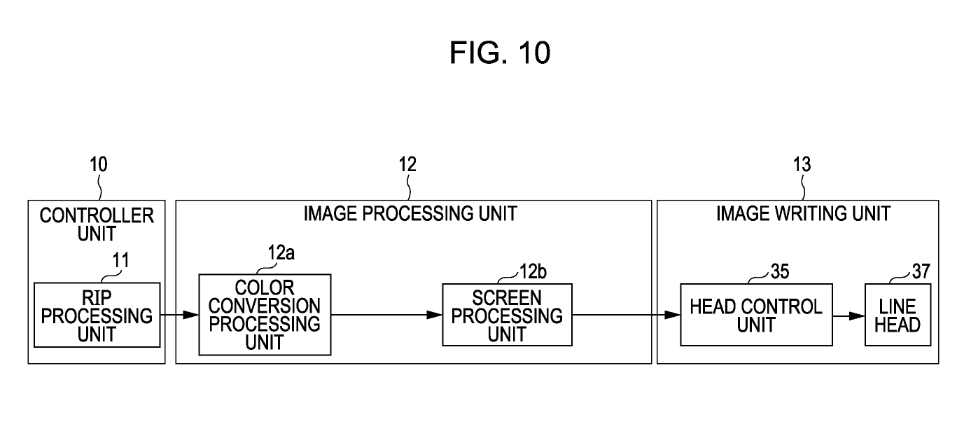

FIG. 10 is a diagram that schematically illustrates an example of the configuration of related art in which front-back registering is not taken into consideration. In FIG. 10, a controller unit 10, which is provided in an RIP server or the like, includes the RIP processing unit 11. An image processing unit 12, which is also provided in the RIP server, includes the color conversion processing unit 12a and the screen processing unit 12b described above. An image writing unit 13 is provided in a printer. The image writing unit 13 includes the head control unit 35 and line heads 37.

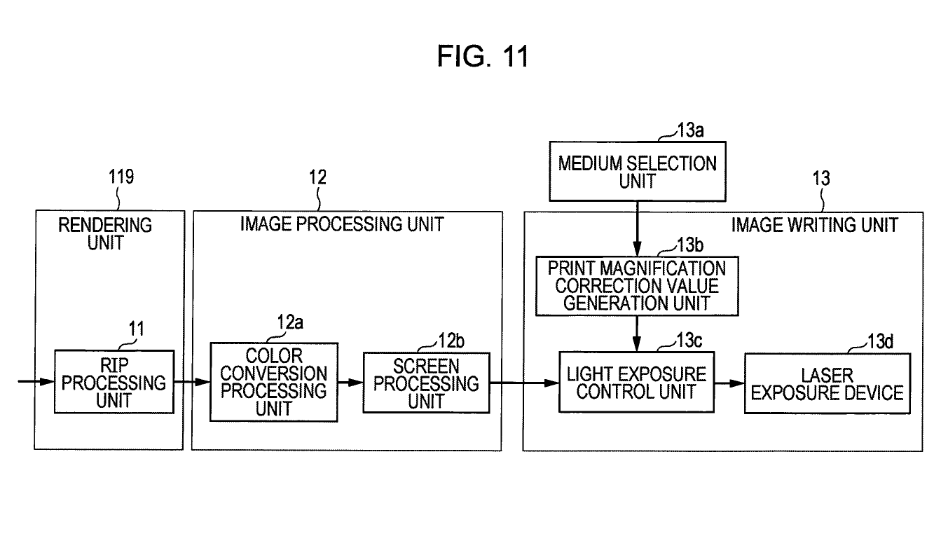

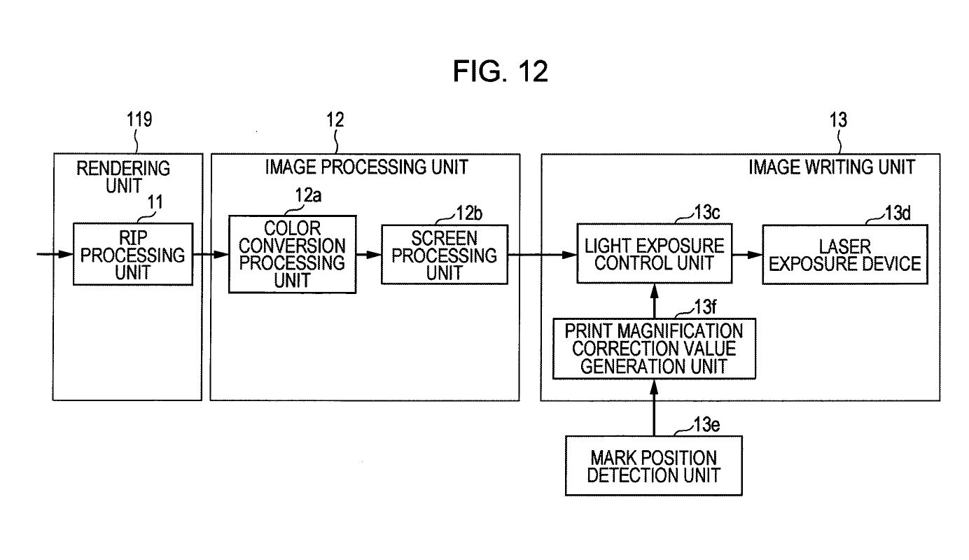

FIG. 11 is a block diagram that illustrates an example of the detailed configuration of the image writing unit 13 illustrated in FIG. 10. FIG. 12 is a block diagram that illustrates another example of the detailed configuration of the image writing unit 13 illustrated in FIG. 10. In the illustrated example of FIG. 11, the image writing unit 13 includes a print magnification correction value generation unit 13b, a light exposure control unit 13c, and a laser exposure device 13d. The print magnification correction value generation unit 13b receives a signal sent from a medium selection unit 13a. In this example, the image writing unit 13 performs print magnification correction when a medium is selected after screen processing that has been performed by the image processing unit 12.

In the illustrated example of FIG. 12, the image writing unit 13 includes a print magnification correction value generation unit 13f, the light exposure control unit 13c, and the laser exposure device 13d. The print magnification correction value generation unit 13f receives a signal sent from a paper mark position detection unit 13e. In this example, the image writing unit 13 performs print magnification correction when a mark position is detected after screen processing that has been performed by the image processing unit 12.

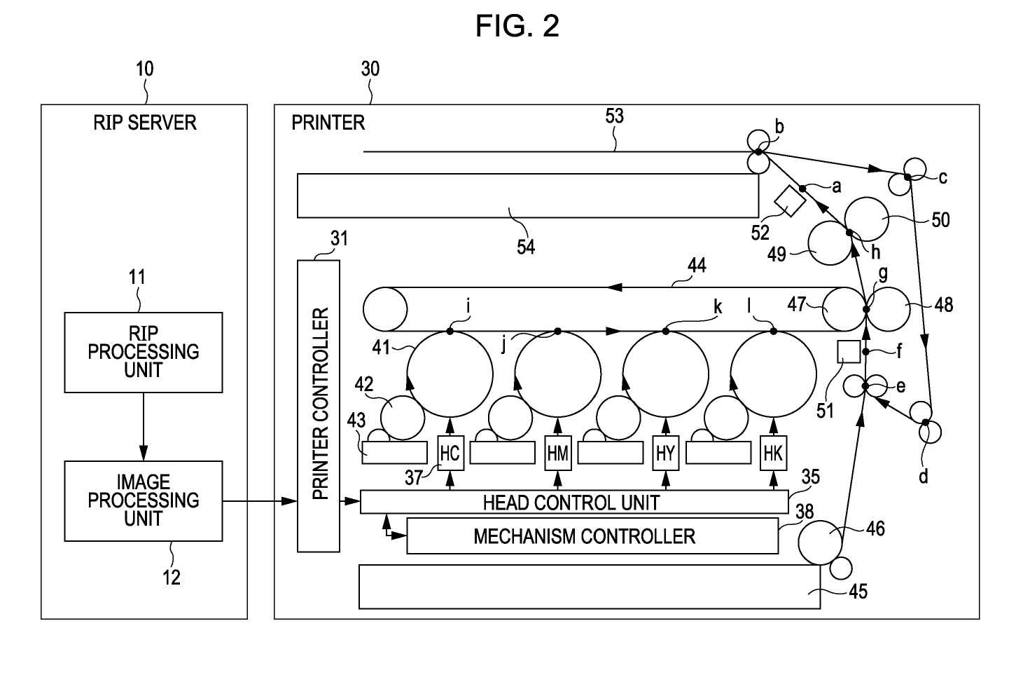

FIG. 2 is a diagram that schematically illustrates an example of the overall configuration of a printing system according to an exemplary embodiment of the invention. With reference to FIG. 2, the flow of print processing according to an exemplary embodiment of the invention is explained below. The RIP processing unit 11 and the image processing unit 12 are provided in the RIP server 10. The control unit of a printer 30 includes a printer controller 31, the head control unit 35, and a mechanism controller 38.

A photosensitive member (latent image carrier) 41 for each of C, M, Y, and K, a development roller 42 for each of C, M, Y, and K, a toner container 43 for each of C, M, Y, and K, the line head 37 for each of C, M, Y, and K, and the mechanism controller 38 are provided as main components of the printer 30. A plurality of light-emitting elements such as LEDs or organic electroluminescence (EL) elements is provided on the line head 37. The light-emitting elements are arranged in the axial direction (a first direction) of the photosensitive member 41. The light-emitting elements may be arranged not only in the axial direction of the photosensitive member 41 but also in the direction of rotation of the photosensitive member 41 (a second direction that is orthogonal to the first direction) in two-dimensional array. A latent image formed on each photosensitive member 41 is transferred therefrom onto an intermediary image transfer belt 44 in primary transfer process. Then, the image is transferred onto the surface of a sheet of paper 53 at an image transfer unit that includes a pressure application roller 48 and a secondary image transfer roller 47 in secondary transfer process. Next, an image fixation unit that includes a pressure application roller 50 and an image fixation roller 49 thermally fixes the latent image transferred onto the sheet. After the thermal fixing processing, the sheet is ejected onto a paper-eject tray 54 in a case where an image is printed on the front side of the sheet only. A certain amount of paper that is to be processed for printing is set in a paper-feed tray 45.

In a digital printing machine such as a POD machine, the RIP processing unit 11 performs rendering processing on a print file that has been sent from an external device such as a client PC or the like to the RIP server 10 via a network to convert it into a raster image. After the rendering, the image processing unit 12 performs color conversion processing and screen processing (i.e., halftone processing) on the rasterized image and then transmits the processed image to the printer 30 as bit image print data. Upon receiving the print data sent from the RIP server 10, the printer controller 31 internally transfers the received data to the head control unit 35 inside the printer 30. The head control unit 35 performs correction processing that is unique to each line head 37 and reflects mechanically dependent individual specificity on the bit image data for the light exposure control of the line heads 37.

The printer 30 shown in FIG. 2 is a tandem type printer. Through the light exposure control of the line heads 37, a latent image is formed on each of the C, M, Y, and K photosensitive members 41. After development processing, each toner image is transferred onto the intermediary image transfer belt 44. At a secondary image transfer point g, the toner image is transferred onto a sheet of printing paper (recording target medium) 53 that has been sent from the paper-feed tray 45 through points e and f on a path of paper transportation. The point f is a detection point at which a paper-edge detection sensor S1 (51) detects an edge of paper.

Thereafter, the heating roller (i.e., image fixation roller) 49 thermally fixes the toner image transferred on the sheet of paper 53 at a point h with pressure application. Then, a line sensor S2 (52) measures an edge and the position of a register mark in two dimensions at a point “a”. In a case where single-side (front-side) printing is performed, the sheet of paper 53 with the fixed image is ejected onto the paper-eject tray 54. In a case where double-side printing is performed, the sheet of paper 53 with the fixed image is transported through points b, c, d, e, f, and g on a transportation path for the transferring of a toner image on the other side (i.e., the back) of the sheet 53. After fixation processing, the sheet 53 is ejected onto the paper-eject tray 54.

When double-side printing is performed, front-back registering is required so as not to cause a shift between a print position on the front of a piece of paper and a print position on the back thereof. For this reason, it is necessary at the point g to align the back register marks of a sheet of paper, which are printed on the back of the sheet, for printing a toner image thereon with front register marks, which are printed on the front at four corners of the sheet, with high precision. An aspect of the invention discloses a technique for achieving front-back registering with high precision.

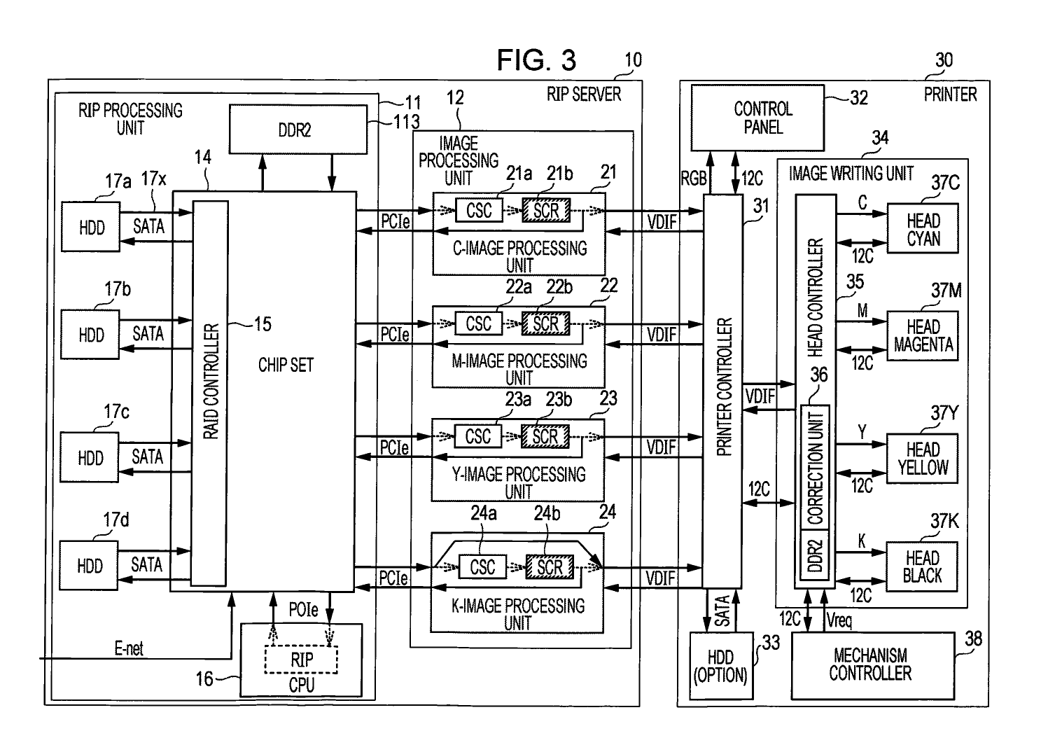

FIG. 3 is a block diagram that schematically illustrates an example of the overall configuration of an electronic control unit of an electro-photographic digital printing machine according to an exemplary embodiment of the invention, which forms a latent image on each photosensitive member. The RIP server 10 is a section that converts a document file that has been sent from an external device (not shown in the drawing) such as a client PC connected to the RIP server 10 via the Ethernet (E-net) or the like into bit image data that corresponds to print pixels on a sheet of paper on a one-to-one basis. Generally, many PC technologies are employed in the RIP server 10. The components of the RIP server 10 can be roughly separated into the RIP processing unit 11, which is software, and the image processing unit 12, which is hardware. The RIP processing unit 11 performs vector/raster conversion processing. The image processing unit 12 performs RGB/CMYK color conversion processing (CSC) and screen processing (SCR) for printing.

Note that it is electric components only that are shown in FIG. 3 as the components of the printer 30. An image writing unit 34 shown in FIG. 3 includes the head control unit 35, which interfaces with the printer controller 31 and controls light exposure operation, and further includes the line heads 37C, 37M, 37Y, and 37K. Specifically, four line heads and the head control unit 35 for writing C, M, Y, and K light exposure data into the respective line heads are provided in the image writing unit 34. A correction unit 36 and a memory (DDR2) are provided in the head control unit 35. A storage device (HDD) 33 is connected to the printer controller 31. The head control unit 35 is connected to the mechanism controller 38.

A memory (DDR2) 113, a chip set 14, a CPU 16, and storage devices (HDD) 17a, 17b, 17c, and 17d are provided in the RIP processing unit 11. The chip set 14 includes a RAID controller 15. The storage devices (HDD) 17a, 17b, 17c, and 17d are connected to the RAID controller 15 via SATA (serial ATA). The chip set 14 is connected to the CPU 16 via PCIe. The image processing unit 12 includes a C image processing unit 21, an M image processing unit 22, a Y image processing unit 23, and a K image processing unit 24. The C, M, Y, and K image processing units 21, 22, 23, and 24 include color conversion units (CSC) 21a, 22a, 23a, and 24a and screen processing units (SCR) 21b, 22b, 23b, and 24b, respectively. The chip set 14 of the RIP processing unit 11 is connected to each of the color conversion units (CSC) 21a, 22a, 23a, and 24a of the image processing unit via PCIe. In addition, each of the screen processing units (SCR) 21b, 22b, 23b, and 24b is connected to the printer controller 31 via a video data interface (VDIF).

In FIG. 3, the image processing unit 12 is made up of four image processing units that respectively generate C, M, Y, K individual plane data. As another example, with the splitting of a one-page print image on a band basis, four mage processing units may perform the color conversion processing of the CSC 21a, 22a, 23a, and 24a and the screen processing of the SCR 21b, 22b, 23b, and 24b in four parallel sets. Print processing may be performed at the printer 30 immediately after RIP processing and image processing performed at the RIP server 10 as a part of continuous processing flow. Or, after RIP processing and image processing performed at the RIP server 10, print data may be temporarily stored in the HDDs (17a, 17b, 17c, and 17d) of the RIP server 10. In the latter case, the data read out of the HDDs are transmitted to the printer 30 for printing on a recording target medium thereat.

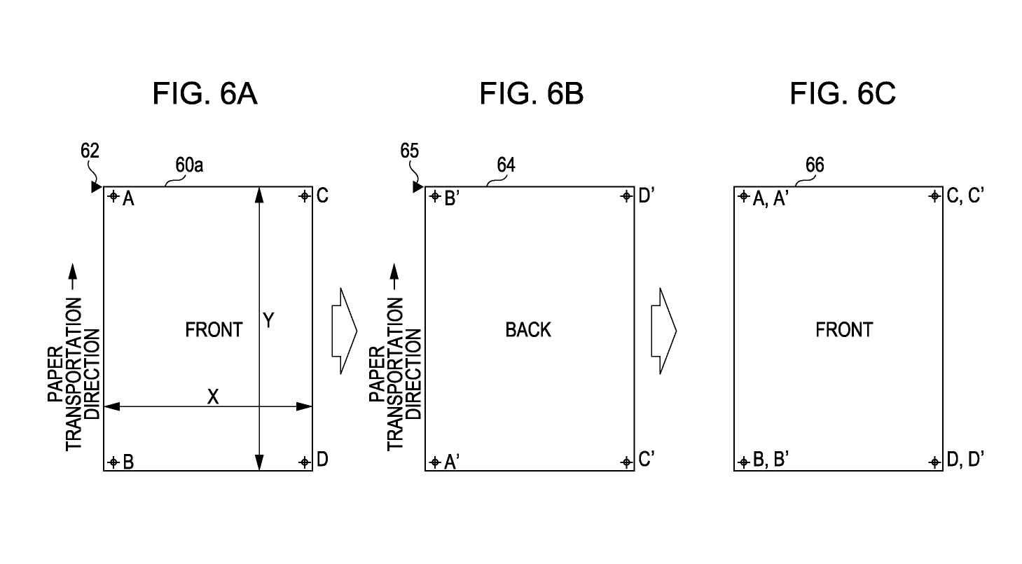

FIG. 6 is a set of diagrams that schematically illustrates an example of basic processing according to an exemplary embodiment of the invention. FIG. 6A is a diagram that schematically illustrates an example of the state of a recording target medium (hereinafter referred to as “sheet of paper”) when an image is printed on the front thereof. The reference numeral 60a denotes the size of the sheet of paper before the printing of an image on the front thereof and the position of the leading edge of the sheet. The reference numeral 62 denotes the detected position of a front-side edge of the sheet of paper. When an image is printed on the front of the sheet of paper, the position of a register mark A (a mark that shows a print reference position) is used as reference. FIG. 6B is a diagram that schematically illustrates an example of the state of the sheet of paper when an image is printed on the back 64 thereof. The reference numeral 65 denotes the detected position of a reverse-side edge of the sheet of paper.

The letters A′, B′, C′ and D′ denote the positions of register marks when an image is printed on the back 64 of the sheet of paper. In the present embodiment of the invention, the position of the sheet of paper is corrected in such a way as to align (i.e., register) the position of the register mark B′ printed on the back 64 of the sheet of paper with the position of a register mark B printed on the front thereof. FIG. 6C shows the state of the sheet of paper after printing on both sides thereof. The reference numeral 66 denotes the size of the sheet of paper at the time of completion of printing on both the front and the back thereof and the position of the leading edge of the sheet. In this example, the positions of register marks ΔA′, BB′, CC′, and DD′ when printing on the back of the sheet of paper has been completed coincide therewith. As described above, in the present embodiment of the invention, even when the size of a sheet of paper changes due to paper shrinkage that occurs in the course of image fixation processing, a shift between a print position on the front thereof and a print position on the back thereof does not occur.

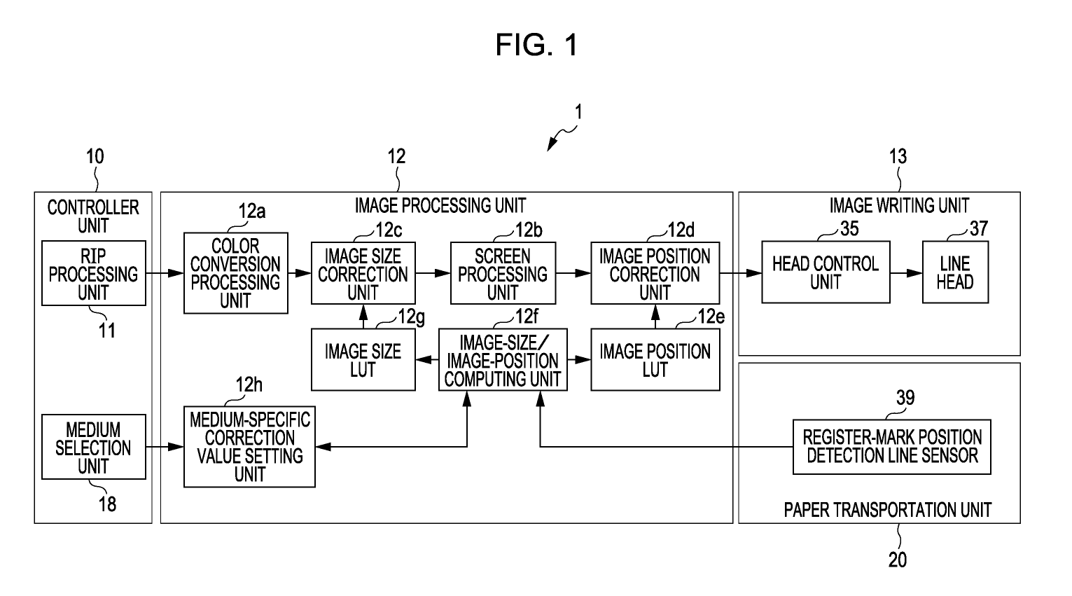

FIG. 1 is a block diagram that illustrates a detailed example of the configuration of a registering section of an image forming apparatus 1 according to an exemplary embodiment of the invention, which performs front-back registering processing on a recording target medium. The controller unit 10, which corresponds to the RIP server illustrated in FIG. 2, includes the RIP processing unit 11 and a medium selection unit 18. The image processing unit 12 includes the image size correction unit 12c and the image position correction unit 12d. The image size correction unit 12c is provided as an upstream block viewed from the screen processing unit 12b. The image position correction unit 12d is provided as a downstream block viewed from the screen processing unit 12b. Besides the screen processing unit 12b, the image size correction unit 12c, and the image position correction unit 12d, the image processing unit 12 includes the color conversion processing unit 12a, an image size lookup table (LUT) 12g, an image position LUT 12e, an image-size/image-position computing unit 12f, and a medium-specific correction value setting unit 12h. The medium selection unit 18, which is provided in the controller unit 10, transmits the data of a selected medium to the medium-specific correction value setting unit 12h, which is provided in the image processing unit 12. The image writing unit 13 includes the head control unit 35 and the line head 37. A register-mark position detection line sensor 39 is provided in a paper transportation unit 20.

The color conversion processing unit 12a of the image processing unit 12 performs color conversion processing on image data that has been subjected to RIP processing at the controller unit 10. Then, the image size correction unit 12c performs image size correction processing on the color-converted data on the basis of a correction value set in the image size LUT 12g. When printing is performed on a first side (e.g., the front) of paper, a reference correction value that is dependent on the type of paper (medium) selected at the controller unit 10 is set through the image-size/image-position computing unit 12f as an image size correction value in the image size LUT 12g. When printing is performed on a second side (e.g., the back) of paper, an image size correction value calculated by the image-size/image-position computing unit 12f on the basis of information on the position of a register mark sent from the register-mark position detection line sensor 39 is set in the image size LUT 12g. A medium-specific correction value includes print correction positions A0, B0, C0, and D0 and print target positions A1, B1, C1, and D1. A more detailed explanation of the print correction positions and the print target positions will be given later. In the following description of this specification, the front of a recording target medium and the back thereof are taken as the first side and the second side thereof, respectively. However, the scope of the invention is not limited to description of the present embodiment. The first side of a recording target medium may be either of the front and the back thereof. The second side of the recording target medium is the other side.

The screen processing unit 12b performs screen processing on the image data whose image size has been corrected at the image size correction unit 12c. Then, the screen-processed data is sent to the image position correction unit 12d. The image position correction unit 12d performs image position correction processing on the screen-processed data on the basis of data set in the image position LUT 12e. When printing is performed on the first side (e.g., the front) of paper, a reference correction value that is dependent on the type of medium selected at the controller unit 10 is set through the image-size/image-position computing unit 12f as an image position correction value in the image position LUT 12e. When printing is performed on the second side (e.g., the back) of paper, print image target position information and print image position relative correction information, which are calculated by the image-size/image-position computing unit 12f on the basis of information on the leading edge of a sheet of paper and information on the position of a register mark that have been sent from the register-mark position detection line sensor 39, are set in the image position LUT 12e.

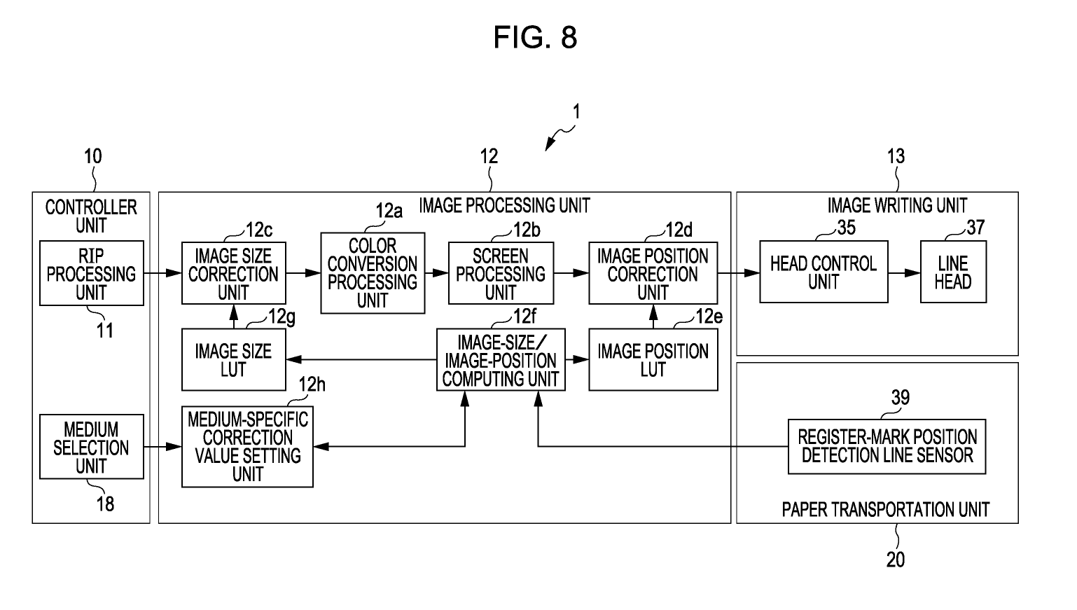

The medium-specific correction value is updated at the medium-specific correction value setting unit 12h on the basis of image size correction information and image position correction information that are obtained at each printing. The image data whose print position has been corrected at the image position correction unit 12d is sent to the image writing unit 13. The image data is converted at the head control unit 35 into control data that is used for performing light exposure control on the line head 37. A latent image is formed on a photosensitive member. Correction processing will be explained in detail later. In the illustrated example of FIG. 1, the image size correction unit 12c is provided as a downstream block viewed from the color conversion processing unit 12a. However, the scope of the invention is not limited to such an exemplary configuration. For example, as illustrated in a block diagram of FIG. 8, the color conversion processing unit 12a may be provided as a downstream block viewed from the image size correction unit 12c. In FIG. 8, the screen processing unit 12b performs screen processing on the image data whose image size has already been corrected at the image size correction unit 12c. In this respect, it can be said that the block sequence of FIG. 8 is fundamentally the same as that of FIG. 1.

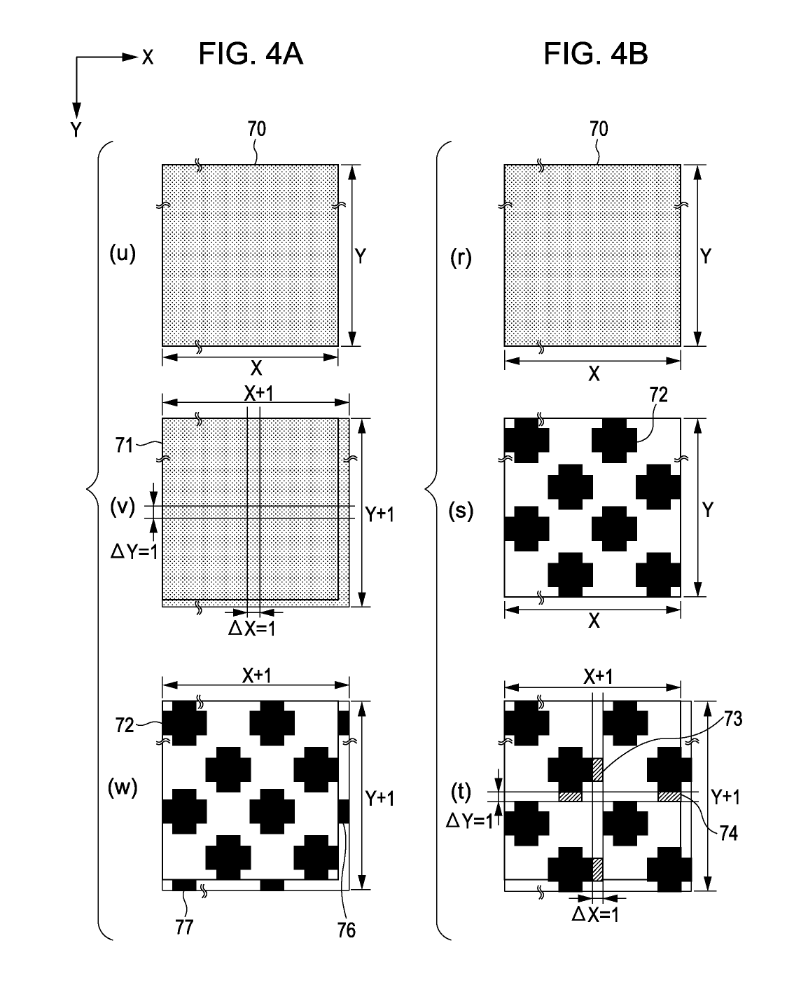

FIG. 4 is a set of diagrams that explains an advantage of performing image size correction processing before screen processing as illustrated in FIG. 1. FIG. 4 shows an image subjected to size correction in an enlarged view. Three drawings of FIG. 4A, which are shown on the left side, show the flow of size correction processing according to the present embodiment of the invention and the state of an image according thereto. Three drawings of FIG. 4B, which are shown on the right side, show a processing flow according to related art in which size correction processing is performed after screen processing (after image processing) and the state of an image according thereto.

The upper right drawing (r) shows a half tone image before screen processing (hereinafter referred to as pre-screen half tone image), which is denoted as 70. The center drawing on the right side (s) shows a screen-processed image. The reference numeral 72 denotes an image. The lower right drawing (t) shows a result of the enlarging of an image size with the addition of one pixel line 73 in the main scan direction (X direction) and the addition of one pixel line 74 in the sub scan direction (Y direction) for the purpose of correcting the image size after screen processing. The one pixel line 73 added in the main scan direction is shown as ΔX=1. The one pixel line 74 added in the sub scan direction is shown as ΔY=1. Data of a neighboring image is used for interpolation, that is, data filling or embedding, on each additional pixel line as shown by hatched lines.

The upper left drawing (u) shows the pre-screen half tone image 70. The center drawing on the left side (v) shows a result of the enlarging of an image size with the addition of one pixel line in the main scan direction and the addition of one pixel line in the sub scan direction for the purpose of correcting the image size. As in the related-art example, in this example, the one pixel line added in the main scan direction is shown as ΔX=1 whereas the one pixel line added in the sub scan direction is shown as ΔY=1. The lower left drawing (w) shows a result of screen processing performed on the enlarged half tone image. As a matter of course, data 76, 77 for each added one pixel line is filled with a uniform screen.

As understood from FIG. 4, when image size correction processing is performed after screen processing as in the related-art example, a regular screen pattern will be disordered. For this reason, an image obtained as a printing result causes a sense of unnaturalness, visual irregularity, or the like. Specifically, as understood from the center drawing (s) and the lower drawing (t) of FIG. 4B, the position of the image 72 is shifted. When image size correction processing is performed before screen processing as shown in FIG. 4A, it is possible to avoid a regular screen pattern from being disordered. That is, although a pre-screen image is partially enlarged, a screen processing result is covered with a regular screen as illustrated in the lower left drawing (w). For this reason, the result does not cause any sense of unnaturalness, visual irregularity, or the like.

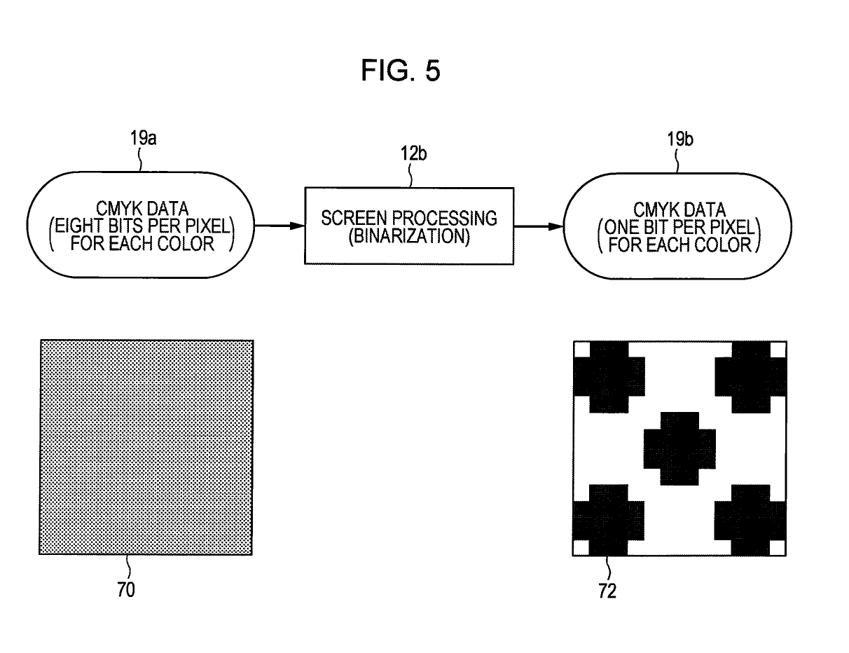

FIG. 5 is a diagram that explains the reason why image position correction processing is performed after screen processing in the present embodiment of the invention. Screen processing, which is called also as halftone processing, is processing for converting multi-level (i.e., multi-value) tone data into binary tone data. The binary tone data format is a format that is used by an offset printing machine and a digital printing machine. As shown by the reference numeral 70 in the lower left part of FIG. 5, input data is gray-scale data in terms of visual sense whatever scaling factor is taken. In contrast, as shown by the reference numeral 72 in the lower right part of FIG. 5, output data has area ratio gray scale of a binary data format as it is magnified.

Generally, CMYK data 19a that is inputted into the screen processing unit 12b contains eight bits per pixel for each color. On the other hand, CMYK data 19b that is outputted from the screen processing unit 12b contains one bit per pixel for each color. That is, the amount of data after screen processing has been reduced to an eighth of the amount of data before screen processing. It is necessary to process a large amount of image data at a high speed in image position correction processing, which holds true for the entire processing of the print-image processing unit 12. For this reason, image position correction processing according to the present embodiment of the invention is performed at a block where the amount of data that has to be processed is as small as possible.

Note that the processing shown in FIG. 5 is carried out as a result of moving the print position of an image as a whole in the main scan direction and the sub scan direction unlike image size correction processing, which is processing in which image data itself is corrected. For this reason, unlike image size correction processing, image quality is not affected even though image position correction processing according to the present embodiment of the invention is performed after screen processing.

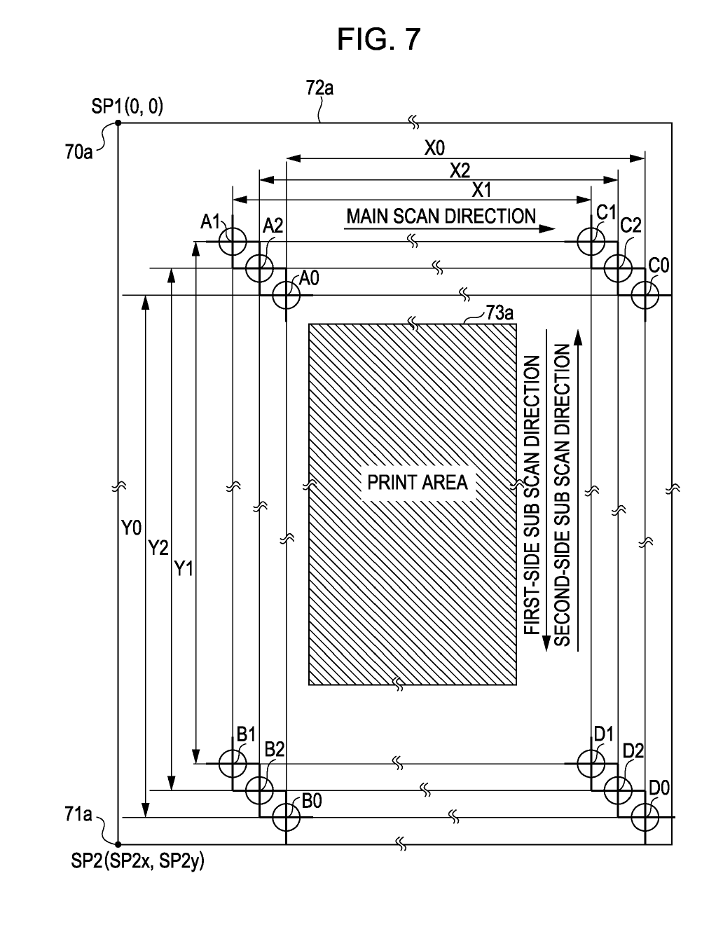

FIG. 7 is a diagram that schematically illustrates an example of the positions of register marks that are put on four corners outside a print image area of a piece of paper for front-back registering processing in double-side printing according to an exemplary embodiment of the invention. The reference numeral 72a denotes the edges of the sheet of paper as a frame. The reference numeral 73a denotes a print area. The reference numeral 70a (SP1) denotes the upper left corner point of the sheet. The upper left corner point 70a is taken as a reference position when an image is printed on the first side (the front) of the sheet. The reference numeral 71a (SP2) denotes the lower left corner point of the sheet. The lower left corner point 71a is taken as a reference position (a second reference position) when an image is printed on the second side (the back) of the sheet. “Print correction positions” are denoted as A0, B0, C0, and D0. “Print target positions” are denoted as A1, B1, C1, and D1. The print correction positions A0, B0, C0, and D0 are positions corrected prior to printing with an aim to obtain the print target positions A1, B1, C1, and D1 after printing while taking paper shrinkage due to thermal fixation and the like on the first side into consideration. Therefore, it is possible to obtain a printing result on the first side that is close to actual size. “Printing result positions” of register marks measured by the register-mark position detection line sensor S2 after printing are denoted as A2, B2, C2, and D2. A sheet of paper is affected in various ways, including mechanically, environmentally, and over time, when it goes through a long path throughout print processes. Because of such various effects, the positions of register marks that are actually printed on the first side thereof are sometimes displaced from the print target positions A1, B1, C1, and D1. The reason why the printing result positions are measured despite the fact that the print correction positions are set is to improve the precision of the positions of register marks (image position) that are printed on the second side thereof in anticipation of such a possibility of displacement. The distance between register marks in the main scan direction (the first direction) is denoted as X0, X1, and X2. The distance between register marks in the sub scan direction (the second direction) is denoted as Y0, Y1, and Y2.

With reference to FIG. 7 as well as FIGS. 1 and 2, the registering (i.e., alignment) of the front side of paper and the reverse side thereof according to the present embodiment of the invention is explained below. Since the entire flow of print processing is the same as that explained earlier with reference to FIG. 2, explanation thereof is omitted here. Image size correction and position correction are explained below while referring to FIG. 7 as a main diagram. Before the explanation of image size correction and position correction, FIG. 7 is briefly explained below. With the origin taken at SP1, the print correction positions are taken at A0, B0, C0, and D0 whereas the print target positions are taken at A1, B1, C1, and D1. The printing result positions A2, B2, C2, and D2 show a result of measurement of the positions of register marks printed actually on the first side (the front) of paper by means of the register-mark position detection line sensor S2 with the corner point SP1 taken as a reference point.

Image size correction is explained below. A print size error (ΔX, ΔY) can be expressed as follows on the basis of the printing result positions, which are obtained as a result of printing on the basis of the aforementioned print correction positions A0, B0, C0, and D0, and the print target positions.

Print target positions: A1 (ax1, ay1), B1 (bx1, by1), C1 (cx1, cy1), and D1 (dx1, dy1)
Printing result positions: A2 (ax2, ay2), B2 (bx2, by2), C2 (cx2, cy2), and D2 (dx2, dy2)
Therefore, the following equations hold true.

X1=cx1−ax1

Y1=by1−ay1

X2=cx2−ax2

Y2=by2−ay2

From the above equations, the print size error in the X direction and the Y direction can be expressed as follows.

ΔX=X2−X1

ΔY=Y2−Y1

The image-size/image-position computing unit 12f shown in FIG. 1 performs the above arithmetic operation. Next, in order to equalize print image size on the second side with print image size on the first side, it is necessary to add or subtract pixels corresponding to the correction value ΔX, ΔY thereto or therefrom in the X and Y directions. The correction is performed at the image size correction unit 12c shown in FIG. 1 on the basis of the correction value ΔX, ΔY set in the image size LUT 12g. The method for correction is explained below.

With the addition of the correction value ΔX, ΔY set in the image size LUT 12g, it is necessary to set the size of an image that is to be printed on the second side as shown by the following formulae: X=X1+ΔX, Y=Y1+ΔY. In accordance with the above formulae, X1 and Y1 are corrected in the respective directions. In the following description, correction in the main scan direction (X direction) only is explained. Since correction in the sub scan direction (Y direction) is performed in the same manner as done in the main scan direction explained below, explanation thereof is omitted here.

When the correction value ΔX is a negative value, the sum of proximate pixels lying at a border between each two of images divided into X1/|ΔX| is found, followed by the substitution of the sum for the two pixels. When the correction value ΔX is a positive value, the sum of proximate pixels lying at a border between each two of images divided into X1/|ΔX| is found, followed by the addition of the sum between the two pixels.

In the above example of image size correction, for enlarging or contracting in the main scan direction, the number of pixels that corresponds to the width of an image is allotted to the image width at equal intervals, followed by insertion or deletion on the basis of information on proximate pixels (tone data). The positions for insertion or deletion may be allotted randomly on a line-by-line basis so as not to cause visual unnaturalness or the like. The number of pixel data is increased or decreased in the same manner as above for the sub scan direction to enlarge or contract an image.

Next, a method for correcting an image position is explained below. Image position correction is performed at the image position correction unit 12d on the basis of the print target positions A1, B1, C1, and D1 set in the image position LUT 12e shown in FIG. 1 and correction values (print position relative error) ΔA, ΔB, ΔC, and ΔD. When the corner point SP1 is taken as a reference point, the print target positions and the printing result positions explained above are expressed as follows.

Print target positions: A1 (ax1, ay1), B1 (bx1, by1), C1 (cx1, cy1), and D1 (dx1, dy1)
Printing result positions: A2 (ax2, ay2), B2 (bx2, by2), C2 (cx2, cy2), and D2 (dx2, dy2)
Accordingly, the print position relative error is expressed as follows.
Print position relative error: ΔA (ax2−ax1, ay2−ay1), ΔB (bx2−bx1, by2−by1), ΔC (cx2−cx1, cy2−cy1), ΔD (dx2−dx1, dy2−dy1)

However, since paper has been switched back over a paper transportation path at the time of printing on the second side (the back), the leading edge of the paper taken as reference is SP2. For this reason, the print target positions and the print position relative error are calculated with the origin of coordinates (0, 0) taken at SP2. Then, the result of calculation is set in the image position LUT 12e.

That is, at the time of printing on the second side (the back), it is necessary to set the corner point (edge) SP2 (SP2x, SP2y) read by the register-mark position detection line sensor S2 as reference (the leading edge of paper), reset the origin of coordinates (0, 0) at SP2, calculate the print target positions A1, B1, C1, and D1 with respect to SP2 (0, 0) and the correction values (print position relative error) ΔA, ΔB, ΔC, and ΔD, and set the result of calculation in the image position LUT 12e.

When the origin of coordinates (0, 0) is reset at SP2, the print target positions and the printing result positions can be expressed as follows.

Print target positions: A1 (ax1−SP2x, SP2y−ay1), B1 (bx1−SP2x, SP2y−by1), C1 (cx1−SP2x, SP2y−cy1), D1 (dx1−SP2x, SP2y−dy1)
Printing result positions: A2 (ax2−SP2x, SP2y−ay2), B2 (bx2−SP2x, SP2y−by2), C2 (cx2−SP2x, SP2y−cy2), D2 (dx2−SP2x, SP2y−dy2)
Accordingly, the print position relative error is expressed as follows.
Print position relative error: ΔA (ax2−ax1, ay1−ay2), ΔB (bx2−bx1, by1−by2), ΔC (cx2−cx1, cy1−cy2), ΔD (dx2−dx1, dy1−dy2)

The image-size/image-position computing unit 12f shown in FIG. 1 performs the arithmetic operation for finding the print target positions and the print position relative error and sets the result of calculation in the image position LUT 12e. At the time of printing on the second side of a piece of paper, image position correction is carried out on the basis of the values set in the image position LUT 12e, thereby performing printing with the registering of the register marks printed on the second side with the register marks printed on the first side. In this way, a print image size and a print image position on the first side and a print image size and a print image position on the second side are registered with high precision when double-side printing is performed. As explained above, through dynamic application of print magnification information and print position information that are dependent on a print target medium and a printing machine to image data before and after screen processing, it is possible to perform front-back registering accurately with a size as close as possible to actual size.

It is preferable that the printing result positions A2, B2, C2, and D2 obtained as a result of printing on the basis of the print correction positions A0, B, C0, and D0 should coincide with the print target positions A1, B1, C1, and D1. Therefore, in the present embodiment of the invention, the medium-specific correction value shown in FIG. 1 is constantly subjected to feedback control to ensure that the printing result positions A2, B2, C2, and D2 obtained as a result of printing on the basis of the print correction positions A0, B0, C0, and D0 coincide with the print target positions A1, B1, C1, and D1. With such feedback control, it is possible to further improve the precision of print image size and print image position.

In the present embodiment of the invention, correction is performed for front-back registering that is applied to a line-head exposure device. However, the scope of the invention is not limited thereto. It may be applied to a laser exposure device. In the present embodiment of the invention, feedback control is performed so as to correct image data before and after screen processing where bit image data of an image is present. On the basis of pre-prepared print target positions and a printing result (printing result positions), an image size correction value and an image position correction value are calculated. With the use of these correction values, image size correction processing and image position correction processing are performed on print image data. In addition, in the present embodiment of the invention, print image size correction and print image position correction are applied to print image data for printing on the first side in advance. With such a method, irrespective of the type of a light exposure device used in the next processing block, and without causing any degradation in the quality of an original image, it is possible to perform front-back register printing with image size correction control and image position correction control while ensuring the dimensional accuracy of an image printed on the first side of a piece of paper and an image printed on the second side thereof.

The present embodiment of the invention has the following features.

(1) For a line head having a fixed pitch of light-emitting elements in the main scan direction (the first direction), a functional block that performs image size correction processing before screen processing is provided as an upstream block viewed from a screen processing block. Therefore, it is possible to finely adjust the size of an image at the time of printing without disordering the arrangement of dots (screen pattern) after screen processing while maintaining print quality.

(2) A functional block that performs image position correction processing after screen processing is provided as a downstream block viewed from a screen processing block. By this means, it is possible to align the position of, that is, register, an image printed on the front of a piece of paper and the position of an image printed on the back thereof with high precision when double-side printing is performed.

(3) The above feature (1) is combined with the above feature (2). With a combination of the features (1) and (2), in front-back registering processing performed when double-side printing is performed, it is possible to register the size and the position of an image printed on the front of a piece of paper and the size and the position of an image printed on the back thereof.

(4) In anticipation of shrinkage that occurs due to thermal fixation, print image size correction and print image position correction are applied to print image data for printing on the first side in advance. By this means, it is possible to obtain a printing result with improved precision in the position of a print image with a print-image size close to actual size.

(5) On the basis of information on the detected positions of register marks printed on the first side of a piece of paper, the positions of register marks printed on the second side thereof are found; a print position in the above feature (2) is found; in addition, a print position correction value is constantly subjected to feedback control. By this means, it is possible to avoid the displacement of a print image due to an environmental change that occurs during continuous printing.

(6) On the basis of information on the detected positions of register marks printed on the first side of a piece of paper, a print size correction value used by the image size correction block in (1) and (4) above is constantly subjected to feedback control. By this means, it is possible to avoid discrepancy in print size due to an environmental change that occurs during continuous printing.

An image forming apparatus and an image forming method for registering the front of a recording target medium and the back thereof with high precision when double-side printing is performed are explained above with description of its principle and an exemplary embodiment. However, the scope of the invention is not limited to the foregoing description. The invention may be modified, adapted, changed, or improved in a variety of modes in its actual implementation.

The entire disclosure of Japanese Patent Application No: 2009-53300, filed Mar. 6, 2009 is expressly incorporated by reference herein.

What is claimed is:

1. An image forming apparatus comprising:
a line head that light emission elements are arranged in a first direction;
a latent image carrier that a latent image is formed;
a developing section that develops the latent image;
a transferring section that transfers the image developed by the developing section onto a recording target medium;
a fixing section that performs thermal fixing on the recording target medium on which the image has been transferred;
a storing section that stores information on variation in size of the thermally fixed recording target medium;
an image data processing section that processes image data for transfer on a first side of the recording target medium on the basis of the variation information stored in the storing section; and
a data outputting section that outputs the processed image data for transfer on the first side of the recording target medium and outputs image data for a second side of the recording target medium, which has not been processed by the image data processing section, to transfer the image data on the second side of the recording target medium.

2. The image forming apparatus according to claim 1, further comprising:
a recording target medium selecting section that selects a type of the recording target medium; and
a variation information correcting section that corrects the information on variation in size of the thermally fixed recording target medium on the basis of the type of the recording target medium selected by the recording target medium selecting section.

3. The image forming apparatus according to claim 1, wherein the image data processing section includes a screen processing section that performs screen processing on the image data; and the screen processing on the image data is performed on the basis of the information on variation in size of the thermally fixed recording target medium.

4. The image forming apparatus according to claim 3, further comprising an image position correcting section that performs image position correction processing on the screen processed image data to correct a position of the image data.

5. The image forming apparatus according to claim 1, further comprising a detecting section that detects a position of a mark formed on the recording target medium.

6. An image forming method comprising:
acquiring information on variation in size of a thermally fixed recording target medium and then performing screen processing on image data on the basis of the acquired variation information;
correcting a position of the screen processed image data;
transferring a first image on a first side of the recording target medium by outputting the image data that has been subjected to the screen processing and the position correction and then performing thermal fixing on the recording target medium on which the first image has been transferred; and
transferring a second image on a second side of the recording target medium and then performing thermal fixing on the recording target medium on which the second image has been transferred.
